(19) United States
(12) Patent Application Publication
(10) Pub. No.: US 2025/0219200 A1
(43) Pub. Date: Jul. 3, 2025

(54) SEALING APPARATUS FOR POUCH TYPE SECONDARY BATTERY AND SEALING METHOD FOR POUCH TYPE SECONDARY BATTERY

(71) Applicant: YOULCHON CHEMICAL CO., LTD., Seoul (KR)

(72) Inventors: Jong Hyuk JUNG, Ansan-si (KR); Nok Jung SONG, Seoul (KR); Hee Sik HAN, Ansan-si (KR); Jin Ho KIM, Ansan-si (KR); Jee Eun JANG, Ansan-si (KR); Han Chul PARK, Ansan-si (KR); Sung Chul SHIN, Ansan-si (KR)

(73) Assignee: YOULCHON CHEMICAL CO., LTD., Seoul (KR)

(21) Appl. No.: 18/991,447

(22) Filed: Dec. 21, 2024

(30) Foreign Application Priority Data
Dec. 22, 2023 (KR) 10-2023-0189929

(51) Int. Cl. H01M 50/105; H01M 10/04; H01M 50/121; H01M 50/124; H01M 50/126

(52) U.S. Cl. CPC H01M 50/105; H01M 10/049; H01M 50/121; H01M 50/1243; H01M 50/126

(57) ABSTRACT

Disclosed are an apparatus and a method for sealing a pouch type secondary battery. Insulation defects are prevented and a long-term reliability, such as a chemical resistance, is improved by evenly forming a polymer material pushed from a sealed portion in a tab part even in an unsealed portion to prevent a thickness of a sealant layer from being smaller when a pouch outer material and a lead tab film are sealed in accommodating a secondary battery by using a pouch outer material including a pouch film stack.

### CROSS-REFERENCE TO RELATED APPLICATION

This application claims the benefit of priority to Korean Patent Application No. 10-2023-0189929, filed in the Korean Intellectual Property Office on Dec. 22, 2023, the entire contents of which are incorporated herein by reference.

### TECHNICAL FIELD

The present disclosure relates to an apparatus for sealing a pouch type secondary battery, and a method for sealing a pouch type secondary battery by using the same.

### BACKGROUND

Recently, as application areas of secondary batteries rapidly expand to not only electric power supply of electronic devices, such as electric, electronic, communication, and computers, but also electric power storage supply of large-area devices, such as vehicles and power storage devices, a demand for high-capacity, high-power, and high-stability lithium secondary batteries is increasing.

A lithium secondary battery is generally manufactured by manufacturing a negative electrode and a positive electrode by applying a positive active material, into and from which lithium ions may be inserted and separated, a negative active material that may adsorb and discharge the lithium ions, and a material, in which a binder and a conductive material are selectively mixed, forming an electrode assembly of a specific shape by stacking them on opposite sides of a separator, and inserting the electrode assembly and a non-aqueous electrolyte into a battery case.

Lithium secondary batteries may be divided into cylindrical secondary batteries, prismatic secondary batteries, and pouch-type secondary batteries according to their structures. Among them, a pouch-type secondary battery is manufactured by accommodating the electrode assembly in a pouch-type sheet and sealing the sheet, and are widely used in vehicle batteries or energy storage devices because their structure is simpler and a capacity per unit volume is larger than those of other types of secondary batteries.

The case of such a pouch-type secondary battery is a pouch-type sheet for protecting the electrodes and the electrolyte from the outside, and is formed of a metal membrane and a polymer material for sealing. In this case, the polymer material of the sealant layer for sealing is a thermoplastic material of an olefin-based material, such as polypropylene and polyethylene, and a thermosetting material is mainly used.

When using the case of the above pouch-type secondary battery, the tab needs to be withdrawn from the case to maintain electrical connection from the electrode assembly accommodated in the case to the outside of the case. Accordingly, when the case of the pouch type secondary battery is sealed, the lead tab film and the pouch type sheet are directly sealed in the tab part.

However, unlike other sealed portions, as illustrated in FIG. 1, in the area that is directly sealed to the lead tab film, the polymer material of the sealant layer is pushed between a sealed portion (sealing portion) formed on the lead tab film after the sealing and an unsealed portion (a portion that is not sealed) in the direction of the accommodation area of the electrode assembly of the pouch type secondary battery case.

Specifically, when a pouch type sheet is directly sealed on the lead tab film in the tab part, a phenomenon, in which the polymer material of the sealant layer is pushed from a sealed portion (sealing portion) to an unsealed portion (a portion that is not sealed), may be identified from the cross-sectional image of the sealed portion in the tab part, as illustrated in FIG. 2. When the lead tab film and the pouch type sheet are sealed in the tab part, the sealed portion is pressed and heated by sealing blocks, and then, the polymer material of the sealant layer is pushed from a sealed portion (sealing portion) formed on the lead tab film to an unsealed portion (a portion that is not sealed). Accordingly, the thickness of the unsealed portion (the portion that is not sealed) is inevitably increased due to the pushed out polymer material, and unlike the sealed portion (the sealing portion), at the unsealed portion (a portion that is not sealed), the pressure and heating by the sealing blocks are only transferred to the ambient pressure and the ambient heat, and the sealant layer cannot be evenly pressed and heated, so that the sealant cannot be uniformly melted on the lead tab film. Accordingly, as illustrated in FIG. 2, the polymer material pushed out from the sealed portion (the sealing portion) flows unevenly in the unsealed portion (the portion that is not sealed), cooling, clumping, and lifting occurs, and thus, the thickness of the sealant layer is smaller than the original thickness of the sealant layer at a portion thereof. When the thinned portion of the sealant layer occurs, a long-term reliability, such as insulation defects and a poor chemical resistance, may be problematic at the corresponding portion.

### SUMMARY

The present disclosure has been made to solve the above-mentioned problems occurring in the prior art while advantages achieved by the prior art are maintained intact.

An aspect of the present disclosure prevents insulation defects and improves a long-term reliability, such as a chemical resistance, by evenly forming a polymer material pushed from a sealed portion in a tab part even in an unsealed portion to prevent a thickness of a sealant layer from being smaller when a pouch outer material and a lead tab film are sealed in accommodating a secondary battery by using a pouch outer material including a pouch film stack.

That is, an aspect of the present disclosure provides an apparatus for sealing a pouch type secondary battery.

An aspect of the present disclosure also provides a method for sealing a pouch type secondary battery by using a sealing apparatus.

The technical problems to be solved by the present disclosure are not limited to the aforementioned problems, and any other technical problems not mentioned herein will be clearly understood from the following description by those skilled in the art to which the present disclosure pertains.

An aspect of the present disclosure provides an apparatus and a method for sealing a pouch type secondary battery.

To solve the above problems, the present disclosure provides an apparatus and a method for sealing a pouch type secondary battery. an apparatus for sealing a pouch type secondary battery, by which an upper pouch film stack, a lower pouch film stack, a lead tab film disposed between the upper pouch film stack and the lower pouch film stack are seated includes a first sealing block configured to press an outer layer of the upper pouch film stack in an area, in which the upper pouch film stack and any one surface of the lead tab film correspond to each other, and a second sealing block configured to press an outer layer of the lower pouch film stack in an area, in which the lower pouch film stack and an opposite surface of the lead tab film correspond to each other, at least one of the first sealing block and the second sealing block includes a first area directly contacting the outer layer of the pouch film stack and a second area not directly connecting the outer layer of the pouch film stack, the second area is provided in a direction of an accommodation space of the pouch type secondary battery, the first area and the second area have a step with respect to a surface, on which the first area directly contacts the outer layer of the pouch film stack, and a third area including an empty space is formed between the second area and the outer layer of the pouch film stack, and the third area has a heated atmosphere compared to external atmospheres of the first area and the second area such that a thickness of an inner layer of the pouch film stack does not have a thinner area than an average thickness of an inner layer of an accommodation space area of the pouch type secondary battery in an area, in which the thickness of the inner layer of the pouch film stack increases adjacent to a lead tab film sealing part, when a cross section of an pouch outer material is identified in a direction being perpendicular to the lead tab film sealing part manufactured to be sealed.

(2) In (1), the step may be 1.25 mm or more and 3.5 mm or less.

(3) In (1), a temperature of the first area may be 180° C. or more and 240° C. or less.

(4) In (1), a temperature of the third area may be 73.0° C. or more and 96.0° C. or less.

A method for sealing a pouch type secondary battery includes disposing an electrode assembly in an accommodation space of the pouch type secondary battery formed by an upper pouch film stack and a lower pouch film stack (S10), disposing a lead tab withdrawn from the electrode assembly, between the upper pouch film stack and the lower pouch film stack, and sealing the upper pouch film stack, the lower pouch film stack, and a lead tab film disposed between the upper pouch film stack and the lower pouch film stack by using a sealing apparatus, and the sealing apparatus is the apparatus of any one of (1) to (4).

(6) In (5), the upper pouch film stack and the lower pouch film stack may include an outer layer, a barrier layer, and an inner layer.

(7) In (6), the inner layer may include at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber.

(8) In (6), the inner layer may include a first sealant layer disposed on the barrier layer, and a second sealant layer disposed on the first sealant layer.

(9) In (8), a melting point of the first sealant layer may be 130° C. or more and 160° C. or less.

(10) In (8), a melting index of the first sealant layer, which is measured in a condition of a temperature of 230° C. and a load of 2.16 kg through an ASTM D1238 method, may be 16 g/10 min or more and 30 g/10 min or less.

(11) In (8), a melting point of the second sealant layer may be 161° C. or more and 180° C. or less.

(12) In (8), a melting point of the second sealant layer may be 120° C. or more and 160° C. or less.

(13) In (8), a melting index of the second sealant layer, which is measured in a condition of a temperature of 230° C. and a load of 2.16 kg through an ASTM D1238 method, may be 5 g/10 min or more and 15 g/10 min or less.

(14) In (5), in the sealing of S30, a sealing temperature may be 180° C. or more and 240° C. or less.

(15) In (5), in the sealing of S30, a sealing time period may be 1.5 seconds or more and 2.7 seconds or less.

(16) In (5), in the sealing of S30, a sealing pressure may be 0.1 MPa or more and 0.5 MPa or less.

### BRIEF DESCRIPTION OF THE DRAWINGS

The above and other objects, features and advantages of the present disclosure will be more apparent from the following detailed description taken in conjunction with the accompanying drawings:

FIG. 1 is an optical image illustrating a sealed portion (a sealing portion) and an unsealed portion (a portion that is not sealed) of a tab part in a case of a pouch type secondary battery;

FIG. 2 is an optical image illustrating a cross section of a sealed portion (a sealing portion) and an unsealed portion (a portion that is not sealed) of a tab part in in a case of a pouch type secondary battery;

FIG. 3 is a schematic view illustrating a sealing apparatus according to an embodiment of the present disclosure;

FIG. 4 is a schematic view illustrating a sealing apparatus according to a conventional technology; and

FIG. 5 is a schematic view illustrating a sealing apparatus according to a comparative example of the present disclosure.

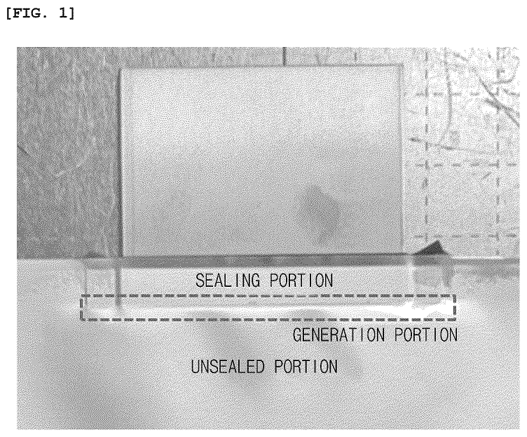

### DETAILED DESCRIPTION

Hereinafter, the present disclosure will be described in more detail to help understanding of the present disclosure.

Terms or words used in the detailed description of the present disclosure and the claims should not be interpreted as being limited to ordinary or dictionary meanings, and should be interpreted as meanings and concepts that are consistent with the technical idea of this present disclosure based on the principle that the inventor may properly define the concepts of the terms to explain his or her invention in the best way.

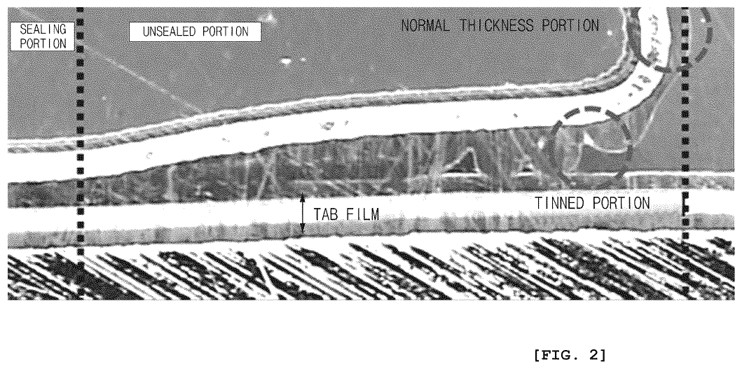

As illustrated in FIG. 4, the sealing apparatus according to a conventional technology uses a 1′-th sealing block 100 that presses an outer layer of an upper pouch film stack UP in an area, in which the upper pouch film stack UP and one surface of a lead tab film “T” correspond to each other, and a 2′-th sealing block 200 that presses an outer layer of a lower pouch film stack BP in an area, in which the lower pouch film stack BP and an opposite surface of the lead tab film “T” correspond to each other, in this case, the 1′-th sealing block 100 includes a 1′-th area 101 that directly contacts the outer layer of the upper pouch film stack UP and a 2′-th area 102 that does not directly contact the outer layer of the upper pouch film stack UP, and the 2′-th sealing block above includes a l′-th area 201 that directly contacts the outer layer of the lower pouch film stack BP and a 2′-th area 202 that does not directly contact the outer layer of the lower pouch film stack BP. However, in the case of using the sealing apparatus according to the conventional technology, when the upper pouch film stack UP, the lower pouch film stack BP, and the lead tab film “T” disposed between the upper pouch film stack UP and the lower pouch film stack BP are sealed, heat and a pressure by the l′-th area 101 of the 1′-th sealing block 100 are applied only to the sealed area of the outer layer of the upper pouch film stack UP, and heat and a pressure by the 1′-th area 201 of the 2′-th sealing block 200 are applied only to the sealed area of the outer layer of the lower pouch film stack BP. Accordingly, when the polymer material of the inner layer of the pouch film stack UP and BP, that is, the sealant layer is pushed out toward the accommodation space of the pouch-type secondary battery during sealing, as illustrated in FIG. 2, unlike the sealed portion (sealing portion), a pressure and heat by the sealing block are only transferred to a peripheral pressure and peripheral heat at the unsealed portion (a portion that is not sealed), and thus the pressure and heat are not evenly transferred, so that the sealant layer cannot be evenly fused onto the lead tab film “T”. Accordingly, the present disclosure provides a sealing apparatus that, when a polymer material of an inner layer of a pouch film stack UP and BP, that is, a sealant layer is pushed out toward an accommodation space of a pouch type secondary battery when the pouch type secondary battery is sealed, may induce the sealant layer to be evenly melted on a lead tab film “T” by forming an area, in which heat may be evenly transferred even to an unsealed portion by using a sealing block.

The present disclosure provides an apparatus for sealing a pouch type secondary battery.

According to an embodiment of the present disclosure, an apparatus for sealing a pouch type secondary battery, by which an upper pouch film stack UP, a lower pouch film stack BP, a lead tab film “T” disposed between the upper pouch film stack UP and the lower pouch film stack BP are seated, may include a first sealing block 10 that presses an outer layer of the upper pouch film stack UP in an area, in which the upper pouch film stack UP and any one surface of the lead tab film “T” correspond to each other, and a second sealing block 20 that presses an outer layer of the lower pouch film stack BP in an area, in which the lower pouch film stack BP and an opposite surface of the lead tab film “T” correspond to each other, at least one of the first sealing block 10 and the second sealing block 20 may include a first area 11 and 21 that directly contacts the outer layer of the pouch film stack and a second area 12 and 22 that does not directly connect the outer layer of the pouch film stack UP and BP, the second area 12 and 22 may be provided in a direction of an accommodation space of the pouch type secondary battery, the first area 11 and 21 and the second area 12 and 22 may have a step with respect to a surface, on which the first area 11 and 21 directly contacts the outer layer of the pouch film stack UP and BP, a third area 13 and 23 including an empty space may be formed between the second area 12 and 22 and the outer layer of the pouch film stack UP and BP, and the third area 13 and 23 may have a heated atmosphere compared to external atmospheres of the first area 11 and 21 and the second area 12 and 22 such that a thickness of an inner layer of the pouch film stack UP and BP does not have a thinner area than an average thickness of an inner layer of an accommodation space area of the pouch type secondary battery in an area, in which the thickness of the inner layer of the pouch film stack increases adjacent to a lead tab film “T” sealing part, when a cross section of an pouch outer material is identified in a direction being perpendicular to the lead tab film sealing part manufactured to be sealed.

According to an embodiment of the present disclosure, the apparatus for sealing a pouch type secondary battery may include the first sealing block 10 that presses the outer layer of the upper pouch film stack UP in the area, in which the upper pouch film stack UP and one surface of the lead tab film “T” correspond to each other, and the second sealing block 20 that presses the outer layer of the lower pouch film stack BP in the area, in which the lower pouch film stack BP and an opposite surface of the lead tab film “T” correspond to each other. A pouch type secondary battery is manufactured by sealing the upper pouch film stack UP and the lower pouch film stack BP during sealing, and a tab needs to be withdrawn to the outside of a case to maintain an electrical connection from an electrode assembly accommodated in an interior of the case to the outside of the case, and a lead tab film “T” and a pouch type sheet are directly sealed in the tab part. In this case, the sealing is carried out by pressing the outer layer of the upper pouch film stack UP in the area, in which the upper pouch film stack UP and any one surface of the lead tab film “T” correspond to each other, through the first sealing block 10, and at the same time, the sealing is carried out by pressing the outer layer of the lower pouch film stack BP in the area, in which the lower pouch film stack BP and an opposite surface of the lead tab film “T” correspond to each other, through the second sealing block 20. In this case, the pressing may be carried out in a state, in which the first sealing block and the second sealing block are heated. In this way, when the sealing is carried out, the upper pouch film stack UP and the lead tab film “T” are thermally fused and sealed to each other in the area, in which the upper pouch film stack UP and any one surface of the lead tab film “T” correspond to each other, and the lower pouch film stack BP and the lead tab film “T” are thermally fused and sealed to each other in the area, in which the lower pouch film stack BP and an opposite surface of the lead tab film “T” correspond to each other. In a detailed example, an area, in which the upper pouch film stack UP and any one surface of the lead tab film “T” correspond to each other, and an area, the lower pouch film stack BP and an opposite surface of the lead tab film “T” correspond to each other, may be areas that are symmetrical to each other with respect to the lead tab film “T”.

According to an embodiment of the present disclosure, at least one of the first sealing block 10 and the second sealing block 20 may include a first area 11 and 21 that directly contact the outer layer of the pouch film stack UP and BP and a second area 12 and 22 that does not directly contact the outer layer of the pouch film stack UP and BP. In a detailed example, each of the first sealing block 10 and the second sealing block 20 may include a first area 11 and 21 that directly contact the outer layer of the pouch film stack UP and BP and a second area 12 and 22 that does not directly contact the outer layer of the pouch film stack UP and BP. Here, when the pouch type secondary battery is sealed, the first areas 11 and 21 correspond to an area that directly presses the outer layers of the upper pouch film stack UP and the lower pouch film stack BP, in an area, the upper pouch film stack UP and any one surface of the lead tab film “T” correspond to each other through the first sealing block 10, and an area, in which the lower pouch film stack BP and an opposite surface of the lead tab film “T” correspond to each other through the second sealing block 20. That is, the sealing is carried out through a press and heat that is directly applied to the outer layers of the upper pouch film stack UP and the lower pouch film stack BP by the first areas 11 and 21.

According to an embodiment of the present disclosure, the second areas 12 and 22 are areas that do not directly contact the outer layer of the upper pouch film stack UP and the outer layer of the lower pouch film stack BP, and no pressure is directly applied to the outer layers of the upper pouch film stack UP and the lower pouch film stack B from the second areas 12 and 22. Accordingly, sealing is not performed in the areas corresponding to the second areas 12 and 22, among the area, in which the upper pouch film stack UP and any one surface of the lead tab film “T” correspond to each other and the lower pouch film stack BP and an opposite surface of the lead tab film “T” correspond to each other through the second sealing block 20. The areas corresponding to the second areas 12 and 22, among the area, in which the upper pouch film stack UP and any one surface of the lead tab film “T” correspond to each other and the lower pouch film stack BP and an opposite surface of the lead tab film “T” correspond to each other through the second sealing block 20, correspond to the unsealed portion when the polymer material of the inner layer of the pouch film stacks UP and BP, that is, the sealant layer is pushed out toward the accommodation space of the pouch type secondary battery when the pouch type secondary battery is sealed. That is, the second areas 12 and 22 are provided in a direction of the accommodation space of the pouch type secondary battery.

According to an embodiment of the present disclosure, in the first sealing block 10 and the second sealing block 20, a step “h” is present in the first area 11 and 12 and the second area 12 and 22 with respect to a surface, on which the first area 11 and 21 directly contacts the outer layer of the pouch film stack UP and BP. That is, the first sealing block 10 and the second sealing block 20 may show an inverse “L” shape due to the step “h” between the first area 11 and 12 and the second area 12 and 22. In this way, when the step “h” is present between the first area 11 and 21 and the second area 12 and 22, a third area 13 and 23 including an empty space between the second area 12 and 22 and the outer layer of the pouch film stack UP and BP. Here, the third area 13 and 23 corresponds to an essential area to solve the problem of the present disclosure in the apparatus for sealing a pouch type secondary battery. In this way, in the apparatus for sealing a pouch type secondary battery, the second area 12 and 22 is provided in the direction of the accommodation space of the pouch type secondary battery, and when the third area 13 and 23 is formed, the third area 13 and 23 corresponds to an area, in which heat may be evenly transferred even to the unsealed portion by using the sealing block, so that the sealant layer may be induced to be evenly fused onto the lead tab film “T” when the polymer material of the inner layer of the pouch film stack UP and BP, that is the sealant is pushed out in the direction of the accommodation space of the pouch type secondary battery when the pouch type secondary battery is sealed. Meanwhile, only by simply forming the third area 13 and 23, the sealant layer cannot be induced to be evenly fused onto the lead tab film “T” when the polymer material of the pouch film stack UP and BP, that is, the sealant layer is pushed out in the direction of the accommodation space of the pouch type secondary battery when the pouch type secondary battery is sealed. Accordingly, the third area 13 and 23 needs to be adjusted to have a heated atmosphere compared to the external atmospheres of the first area 11 and 21 and the second area 12 and 22 so that an area, in which the thickness of the inner layer is thinner than an average thickness of the inner layer of the accommodation space area of the pouch type secondary battery, is not present in an area, in which the thickness of the inner layer of the pouch film stack UP and BP increases adjacent to the lead tab film “T” sealing part when a cross section of the pouch outer material is identified in a direction that is perpendicular to the lead tab film “T” sealing part that is manufactured through sealing.

According to an embodiment of the present disclosure, to create a heated atmosphere compared to an external atmosphere of the first area 11 and 21 and the second area 12 and 22 so that there is no area, in which the thickness of the inner layer is smaller than the average thickness of the inner layer of the accommodation space area of the pouch type secondary battery, in an area, in which the thickness of the inner layer of the pouch film stack UP and BP increases adjacent to the lead tab film “T” sealing part when a cross section of the pouch outer material is identified in a direction that is perpendicular to the lead tab film “T” sealing part manufactured by sealing the third area 13 and 23, it is necessary to adjust thermal energy formed in the third area 13 and 23 through the first sealing block 10 and the second sealing block 20 by adjusting the step “h” between the first area 11 and 21 and the second area 12 and 22. Here, the outer atmospheres of the first area 11 and 21 and the second area 12 and 22 may mean the atmospheres around the outer surfaces of the first area 11 and 21 and the second area 12 and 22, except for the third area 13 and 23, and the heated area compared to the external atmospheres of the first area 11 and 21 and the second area 12 and 22 may mean that the temperature of the third area 13 and 23 is higher than the temperatures around the outer surfaces of the first area 11 and 21 and the second area 12 and 22. Meanwhile, a method for adjusting the thermal energy formed in the third area 13 and 23 through the first sealing block 10 and the second sealing block 20 may be a method of adjusting the step “h” between the first area 11 and 21 and the second area 12 and 22, adjusting the thermal energy applied to the first sealing block 10 and the second sealing block 20, adjusting the thermal energy formed in the third area 13 and 23, or adjusting all of them.

According to an embodiment of the present disclosure, the step “h” between the first area 11 and 21 and the second area 12 and 22 may be 1.25 mm or more and 3.5 mm or less. As a specific example, the step “h” may be 1.25 mm or more, 1.30 mm or more, 1.35 mm or more, 1.40 mm or more, 1.45 mm or more, 1.50 mm or more, 1.55 mm or more, 1.60 mm or more, 1.65 mm or more, 1.70 mm or more, 1.75 mm or more, 1.80 mm or more, 1.85 mm or more, 1.90 mm or more, 1.95 mm or more, or 2.00 mm or more, and further, 3.50 mm or less, 3.40 mm or less, 3.30 mm or less, 3.20 mm or less, 3.10 mm or less, 3.00 mm or less, 2.90 mm or less, 2.80 mm or less, 2.70 mm or less, 2.60 mm or less, 2.50 mm or less, 2.40 mm or less, It may be 2.30 mm or less, 2.20 mm or less, 2.10 mm or less, or 2.00 mm or less.

According to an embodiment of the present disclosure, to adjust the thermal energy applied to the first sealing block 10 and the second sealing block 20, the temperature of the first area 11 and 21 may be 180° C. or more and 240° C. or less. As a specific example, the temperature of the first area 11 and 21 may be 180° C. or more, 185° C. or more, 190° C. or more, 195° C. or more, or 200° C. or more, and may be 240° C. or less, 235° C. or less, 230° C. or less, 225° C. or less, or 220° C. or less.

According to an embodiment of the present disclosure, the temperature of the third area 13 and 23 may be 73.0° C. or more and 96.0° C. or less. As a specific example, the temperature of the third areas 13 and 23 may be 73.0° C. or more, 73.5° C. or more, 74.0° C. or more, 74.5° C. or more, 75.0° C. or more, 75.5° C. or more, 76.0° C. or more, 76.5° C. or more, 77.0° C. or more, 77.5° C. or more, 78.0° C. or more, 78.5° C. or more, 79.0° C. or more, 79.5° C. or more, 80.0° C. or more, 80.5° C. or more, or 81.0° C. or more, and may be 96.0° C. or less, 95.5° C. or less, 95.0° C. or less, 94.5° C. or less, 94.0° C. or less, 93.5° C. or less, 93.0° C. or less, 92.5° C. or less, 92.0° C. or less, or 91.5° C. or less.

According to an embodiment of the present disclosure, an apparatus for sealing a pouch type secondary battery, by which an upper pouch film stack UP, a lower pouch film stack BP, a lead tab film “T” disposed between the upper pouch film stack UP and the lower pouch film stack BP are seated, may include a first sealing block 10 that presses an outer layer of the upper pouch film stack UP in an area, in which the upper pouch film stack UP and any one surface of the lead tab film “T” correspond to each other, and a second sealing block 20 that presses an outer layer of the lower pouch film stack BP in an area, in which the lower pouch film stack BP and an opposite surface of the lead tab film “T” correspond to each other, at least one of the first sealing block 10 and the second sealing block 20 may include a first area 11 and 21 that directly contacts the outer layer of the pouch film stack and a second area 12 and 22 that does not directly connect the outer layer of the pouch film stack UP and BP, the second area 12 and 22 may be provided in a direction of an accommodation space of the pouch type secondary battery, the first area 11 and 21 and the second area 12 and 22 may have a step with respect to a surface, on which the first area 11 and 21 directly contacts the outer layer of the pouch film stack UP and BP, a third area 13 and 23 including an empty space may be formed between the second area 12 and 22 and the outer layer of the pouch film stack UP and BP, and the step “h” may be 1.25 mm or more and 3.5 mm or less.

According to an embodiment of the present disclosure, an apparatus for sealing a pouch type secondary battery, by which an upper pouch film stack UP, a lower pouch film stack BP, a lead tab film “T” disposed between the upper pouch film stack UP and the lower pouch film stack BP are seated, may include a first sealing block 10 that presses an outer layer of the upper pouch film stack UP in an area, in which the upper pouch film stack UP and any one surface of the lead tab film “T” correspond to each other, and a second sealing block 20 that presses an outer layer of the lower pouch film stack BP in an area, in which the lower pouch film stack BP and an opposite surface of the lead tab film “T” correspond to each other, at least one of the first sealing block 10 and the second sealing block 20 may include a first area 11 and 21 that directly contacts the outer layer of the pouch film stack and a second area 12 and 22 that does not directly connect the outer layer of the pouch film stack UP and BP, the second area 12 and 22 may be provided in a direction of an accommodation space of the pouch type secondary battery, the first area 11 and 21 and the second area 12 and 22 may have a step with respect to a surface, on which the first area 11 and 21 directly contacts the outer layer of the pouch film stack UP and BP, a third area 13 and 23 including an empty space may be formed between the second area 12 and 22 and the outer layer of the pouch film stack UP and BP, and the temperature of the first area 11 and 21 may be 180° C. or more and 240° C. or less.

According to an embodiment of the present disclosure, an apparatus for sealing a pouch type secondary battery, by which an upper pouch film stack UP, a lower pouch film stack BP, a lead tab film “T” disposed between the upper pouch film stack UP and the lower pouch film stack BP are seated, may include a first sealing block 10 that presses an outer layer of the upper pouch film stack UP in an area, in which the upper pouch film stack UP and any one surface of the lead tab film “T” correspond to each other, and a second sealing block 20 that presses an outer layer of the lower pouch film stack BP in an area, in which the lower pouch film stack BP and an opposite surface of the lead tab film “T” correspond to each other, at least one of the first sealing block 10 and the second sealing block 20 may include a first area 11 and 21 that directly contacts the outer layer of the pouch film stack and a second area 12 and 22 that does not directly connect the outer layer of the pouch film stack UP and BP, the second area 12 and 22 may be provided in a direction of an accommodation space of the pouch type secondary battery, the first area 11 and 21 and the second area 12 and 22 may have a step with respect to a surface, on which the first area 11 and 21 directly contacts the outer layer of the pouch film stack UP and BP, a third area 13 and 23 including an empty space may be formed between the second area 12 and 22 and the outer layer of the pouch film stack UP and BP, and the temperature of the third area 12 and 23 may be 73.0° C. or more and 96.0° C. or less.

The present disclosure provides a method for sealing a pouch type secondary battery.

According to an embodiment of the present disclosure, the method for sealing a pouch type secondary battery may use the apparatus for sealing a pouch type secondary battery. In a detailed example, a method for sealing a pouch type secondary battery includes disposing an electrode assembly in an accommodation space of the pouch type secondary battery formed by an upper pouch film stack UP and a lower pouch film stack BP (S10), disposing a lead tab “T” withdrawn from the electrode assembly, between the upper pouch film stack UP and the lower pouch film stack BP, and sealing the upper pouch film stack UP, the lower pouch film stack BP, and a lead tab film “T” disposed between the upper pouch film stack UP and the lower pouch film stack BP by using a sealing apparatus, the sealing apparatus is the apparatus described above.

According to an embodiment of the present disclosure, the electrode assembly may be an electrode assembly formed of a positive electrode, a negative electrode, and a separator like a non-aqueous electrolyte lithium secondary battery, and may be an electrode assembly including a positive electrode, a negative electrode, a solid electrolyte layer, and a separator, if necessary when the secondary battery is an all-solid state battery.

According to an embodiment of the present disclosure, the upper pouch film stack UP and the lower pouch film stack BP may include an outer layer, a barrier layer, and an inner layer.

According to an embodiment of the present disclosure, the outer layer is a layer that is located on the outer surface of the pouch film stack UP and BP, and may include at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber.

According to an embodiment of the present disclosure, the outer layer may be configured as a stack of two or more layers in terms of diversifying functions. As a specific example, the outer layer may include a surface protective layer and a stretching assisting layer. Here, the surface protective layer is a layer that constitutes the outermost outer layer of the pouch film stack UP and BP, and may be a layer that primarily protects the pouch outer material from the external environment, and the stretching assisting layer may be a layer that assists adhesion between the surface protective layer and the barrier layer, and simultaneously prevents the surface protective layer and the barrier layer from being separated from each other when the surface protective layer and the barrier layer are stretched.

According to an embodiment of the present disclosure, the surface protective layer may include at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber. The component of the surface protective layer may be selected and used within a range of mechanical properties that do not impair a durability, a heat resistance, a pinhole resistance, a chemical resistance, and an electrical insulation, which function as the surface protective layer of a pouch film stack UP and BP. As a specific example, the surface protective layer may include polyethylene terephthalate having excellent durability, a heat resistance, a pinhole resistance, a chemical resistance, and electrical insulation properties, and as a more specific example, may be a membrane or film formed of polyethylene terephthalate.

According to an embodiment of the present disclosure, the stretching assisting layer may include at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber. The component of the stretching assisting layer may be selected and used within a range of mechanical properties that do not impair the function of the pouch outer material as a stretching assisting layer. For example, the stretching assisting layer may include nylon that is easily adhered to the surface protective layer and has a similar behavior to the barrier layer, and more particularly, may be a membrane or a film formed of nylon.

According to one embodiment of the present disclosure, the surface protective layer may have an average thickness of 10 μm or more and 20 μm or less. As a specific example, an average thickness of the surface protective layer may be 10 μm or more, 11 μm or more, or 12 μm or more, and may be 20 μm or less, 19 μm or less, 18 μm or less, 17 μm or less, 16 μm or less, 15 μm or less, 14 μm or less, 13 μm or less, or 12 μm or less, and it is possible to prevent the secondary battery from being excessively thickened by the exterior material while securing the surface protecting effect in this range.

According to an embodiment of the present disclosure, an average thickness of the stretching assisting layer may be 15 μm or more and 30 μm or less. As a specific example, an average thickness of the surface protective layer may be 15 μm or more, 16 μm or more, 17 μm or more, 18 μm or more, 19 μm or more, 20 μm or more, 21 μm or more, 22 μm or more, 23 μm or more, 24 μm or more, or 25 μm or more, and further may be 30 μm or less, 29 μm or less, 28 μm or less, 27 μm or less, 26 μm or less, or 25 μm or less, and may further improve the adhesion force between the surface protective layer and the barrier layer while securing a behavior similar to that of the barrier layer when being stretched with the barrier layer within this range.

According to an embodiment of the present disclosure, the barrier layer is a layer located at the center of the pouch film stack UP and BP, and secures a mechanical strength of the pouch film stack, and prevents gases and moisture from entering and exiting the inside and outside of the secondary battery, and in particular, may be a layer that serves to prevent an electrolyte from leaking in the secondary battery using a non-aqueous electrolyte. The barrier layer may be a foil that is formed of a metal to perform the above function, and as a detailed example, may include at least one selected from the group consisting of aluminum, iron, copper, and nickel.

According to an embodiment of the present disclosure, the barrier layer may include aluminum in an aspect of securing a suitable mechanical strength with the pouch outer material, preventing a weight increase due to the pouch outer material, having an excellent formability, and sufficiently securing a role as a barrier layer, and as a more specific example, it may be an aluminum foil.

According to one embodiment of the present disclosure, the barrier layer may have an average thickness of 40 μm or more and 90 μm or less. For example, an average thickness of the barrier layer may be 40 μm or more, 41 μm or more, 42 μm or more, 43 μm or more, 44 μm or more, 45 μm or more, 46 μm or more, 47 μm or more, 48 μm or more, 49 μm or more, 50 μm or more, 51 μm or more, 52 μm or more, 53 μm or more, 54 μm or more, 55 μm or more, 56 μm or more, 57 μm or more, 58 μm or more, 59 μm or more, or 60 μm or more, and may be 90 μm or less, 89 μm or less, 88 μm or less, 87 μm or less, 86 μm or less, 84 μm or less, 85 μm or less, 83 μm or less, 82 μm or less, 81 μm or less, 80 μm or less, 79 μm or less, 78 μm or less, 77 μm or less, 76 μm or less, 75 μm or less, 74 μm or less, 73 μm or less, 72 μm or less, 71 μm or less, 70 μm or less, 69 μm or less, 68 μm or less, 67 μm or less, 66 μm or less, 65 μm or less, 64 μm or less, 63 μm or less, 62 or less, 61 μm or less, or 60 μm or less. When the barrier layer has an average thickness within the above range, a mechanical strength as the barrier layer may be secured, the formability of the secondary battery may be further improved, and the thickness of the secondary battery may be prevented from being excessively increased by the pouch film stack UP and BP and the weight thereof may be prevented from being increased.

According to one embodiment of the present disclosure, the inner layer is a layer that is located on the inner surface of the pouch film stack UP and BP, and may also be expressed as a sealant layer. Because the sealing parts formed between the pouch film stacks UP and BP and between the lead tab film “T” and the pouch film stacks UP and BP may be formed in the inner layer, and the inner layer is a layer that directly contacts the secondary battery accommodated in the accommodation space formed from the upper pouch film stack UP and the lower pouch film stack BP, it requires both an electrolyte resistance and an insulation resistance, as well as a thermal adhesion and a formability.

According to an embodiment of the present disclosure, the inner layer may include at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber.

According to an embodiment of the present disclosure, the inner layer may be configured as a stack of two or more layers in terms of diversifying functions. In a detailed example, the inner layer may include a first sealant layer disposed on the barrier layer, and a second sealant layer disposed on the first sealant layer. Here, the first sealant layer may be a layer that assists adhesion of the barrier layer and the second sealant layer, and may be a layer that further improves the function as the inner layer, and the second sealant layer is a layer that constitutes the innermost layer of the pouch film stack UP and BP and may be a layer that prevents leakage of the secondary battery, particularly, leakage of the non-aqueous electrolyte while performing sealing.

According to an embodiment of the present disclosure, the first sealant layer may include at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber. As a detailed example, the first sealant layer may be polypropylene in an aspect for improving the peeling strength of the sealing part between the pouch film stack UP and BP and the lead tab film “T”, and maintaining the polymer material pushed out from the sealed portion in the tab part uniformly formed even in the unsealed portion, and as a more detailed example, it may be a membrane or film formed of polypropylene.

According to an embodiment of the present disclosure, the first sealant layer may have a melting point of 130° C. or more and 160° C. or less. As a detailed example, the melting point of the first sealant layer may be 130° C. or more, 131° C. or more, 132° C. or more, 133° C. or more, 134° C. or more, 135° C. or more, 136° C. or more, 137° C. or more, 138° C. or more, 139° C. or more, or 140° C. or more, and 160° C. or less, 159° C. or less, 158° C. or less, 157° C. or less, 155° C. or less, 154° C. or less, 153° C. or less, 152° C. or less, 151° C. or less, 150° C. or less, 149° C. or less, 148° C. or less, 147° C. or less, 146° C. or less, or 145° C. or less. When the melting point of the first sealant layer is adjusted within the above range, a sealing force due to the sufficient adhesion force of the pouch film stack UP and BP and the lead tab film “T” is secured, and the polymer material pushed out from the sealed portion in the tab part is uniformly formed at the unreleased portion, the thickness of the inner layer is prevented from being decreased whereby it is possible to prevent insulation defects and further improve a long-term reliability, such as a chemical resistance.

According to an embodiment of the present disclosure, the first sealant layer may have a melting point of more than 150° C. or more and 180° C. or less. As a detailed example, the first sealant layer may have a melting point of more than 150° C., 151° C. or more, 152° C. or more, 153° C. or more, 154° C. or more, 155° C. or more, 156° C. or more, 157° C. or more, or 158° C. or more, and 180° C. or less, 179° C. or less, 178° C. or less, 177° C. or less, 176° C. or less, 175° C. or less, 174° C. or less, 173° C. or less, 172° C. or less, 171° C. or less, 170° C. or less, 169° C. or less, 168° C. or less, 167° C. or less, 166° C. or less, 165° C. or less, 164° C. or less, or 163° C. or less.

According to an embodiment of the present disclosure, the first sealant layer may have a melting index (230° C., a load of 2.16 kg) of 16 g/10 min or more and 30 g/10 min or less, as measured by the ASTM D1238 method. For example, the melt index (230° C., a load of 2.16 kg) of the first sealant layer may be 16 g/10 min or more, 17 g/10 min or more, 18 g/10 min or more, 19 g/10 min or more, 20 g/10 min or more, or 21 g/10 min or more, and may be 30 g/10 min or less, 29 g/10 min or less, 28 g/10 min or less, 27 g/10 min or less, 26 g/10 min or less, 25 g/10 min or less, or 24 g/10 min or less. When the melting point of the first sealant layer together with the melting index of the first sealant layer are adjusted within the above range, the polymer material pushed out from the sealed portion in the tab part is uniformly formed even in the unsealed portion, and thus, the thickness of the inner layer is prevented from being decreased whereby it is possible to prevent insulation defects and further improve a long-term reliability, such as a chemical resistance.

According to an embodiment of the present disclosure, the first sealant layer may have a melting index (230° C., a load of 2.16 kg) of 5 g/10 min or more and less than 16 g/10 min or less, as measured by the ASTM D1238 method. For example, the melt index (230° C., a load of 2.16 kg) of the first sealant layer may be 5 g/10 min or more, 6 g/10 min or more, 7 g/10 min or more, 8 g/10 min or more, 9 g/10 min or more, and may be less than 16 g/10 min, 15 g/10 min or less, 14 g/10 min or less, 13 g/10 min or less, 12 g/10 min or less, or 11 g/10 min or less.

According to one embodiment of the present disclosure, the first sealant layer may have an average thickness of 10 μm or more and 50 μm or less. For example, the first sealant layer may have an average thickness of 10 μm or more, 11 μm or more, 12 μm or more, 13 μm or more, 14 μm or more, 15 μm or more, 16 μm or more, 17 μm or more, 18 μm or more, 19 μm or more, 20 μm or more, 21 μm or more, 22 μm or more, 23 μm or more, 24 μm or more, 25 μm or more, 26 μm or more, 27 μm or more, 28 μm or more, 29 μm or more, or 30 μm or less, and 50 μm or less, 49 μm or less, 48 μm or less, 47 μm or less, 46 μm or less, 45 μm or less, 44 μm or less, 43 μm or less, 42 μm or less, 41 μm or less, 40 μm or less, 39 μm or less, 38 μm or less, 37 μm or less, 36 μm or less, 35 μm or less, 34 μm or less, 33 μm or less, 32 μm or less, 31 μm or less, or 30 μm or less, and within this range, the sealing force by a sufficient adhesion of the pouch film stack UP and BP and the lead tab film “T” may be further improved.

According to an embodiment of the present disclosure, the second sealant layer may include at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber. As a detailed example, the first second layer may be polypropylene in an aspect for improving the peeling strength of the sealing part between the pouch film stack UP and BP and the lead tab film “T”, and maintaining the polymer material pushed out from the sealed portion in the tab part uniformly formed even in the unsealed portion, and as a more detailed example, it may be a membrane or film formed of non-stretching polypropylene.

According to an embodiment of the present disclosure, the second sealant layer may have a melting point of 161° C. or more and 180° C. or less. As a detailed example, the second sealant layer may have a melting point of 161° C. or more, 162° C. or more, or 163° C. or more, and may be 180° C. or less, 179° C. or less, 178° C. or less, 177° C. or less, 176° C. or less, 175° C. or less, 174° C. or less, 173° C. or less, 172° C. or less, 171° C. or less, 170° C. or less, 169° C. or less, or 168° C. or less. When the melting point of the second sealant layer is adjusted within the above range, the sealing force by a sufficient adhesion between the pouch film stack UP and BP and the lead tab film “T” is secured so that it is possible to prevent insulation defects and further improve a long-term reliability, such as chemical resistance.

According to an embodiment of the present disclosure, the second sealant layer may have a melting point of 120° C. or more and 160° C. or less. As a detailed example, the second sealant layer may have a melting point of 120° C. more, 121° C. more, 122° C. more, 123° C. more, 124° C. more, 125° C. more, 126° C. more, 127° C. more, 128° C. more, 129° C. more, 130° C. more, 131° C. more, 132° C. more, 133° C. more, 134° C. more, 135° C. more, or 136° C. more, and 160° C. or less, 159° C. less, 158° C. or less, 157° C. less, 156° C. or less, 155° C. less, 154° C. less, 153° C. less, 152° C. or less, 151° C. less, 150° C. less, 149° C. less, 148° C. or less, 147° C. less, 146° C. or less, 145° C. less, 144° C. or less, 143° C. less, 142° C. less, 141° C. less, or 140° C. less. When the melting point of the second sealant layer is adjusted within the above range, the polymer material pushed out from the sealed portion in the tab part is uniformly formed even in the unsealed portion, and thus, the thickness of the inner layer is prevented from being decreased whereby it is possible to prevent insulation defects and further improve a long-term reliability, such as a chemical resistance.

According to an embodiment of the present disclosure, the second sealant layer may have a melting index (230° C., a load of 2.16 kg) of 5 g/10 min or more and 15 g/10 min or less, as measured by the ASTM D1238 method. As a detailed example, the melt index (230° C., a load of 2.16 kg) of the first sealant layer may be 5 g/10 min or more, 6 g/10 min or more, 7 g/10 min or more, 8 g/10 min or more, 9 g/10 min or more, and may be 15 g/10 min or less, 14 g/10 min or less, 13 g/10 min or less, or 12 g/10 min or less. When the melting point of the second sealant layer together with the melting index of the second sealant layer are adjusted within the above range, the polymer material pushed out from the sealed portion in the tab part is uniformly formed even in the unsealed portion, and thus, the thickness of the inner layer is prevented from being decreased whereby it is possible to prevent insulation defects and further improve a long-term reliability, such as a chemical resistance.

According to one embodiment of the present disclosure, the second sealant layer may have an average thickness of 30 μm or more and 70 μm or less. For example, the second sealant layer may have an average thickness of 30 μm or more, 31 μm or more, 32 μm or more, 33 μm or more, 34 μm or more, 35 μm or more, 36 μm or more, 37 μm or more, 38 μm or more, 39 μm or more, 40 μm or more, 41 μm or more, 42 μm or more, 43 μm or more, 44 μm or more, 45 μm or more, 46 μm or more, 47 μm or more, 48 μm or more, 49 μm or more, or 50 μm or less, and 70 μm or less, 69 μm or less, 68 μm or less, 67 μm or less, 66 μm or less, 65 μm or less, 64 μm or less, 63 μm or less, 61 μm or less, 62 μm or less, 60 μm or less, 59 μm or less, 58 μm or less, 57 μm or less, 56 μm or less, 55 μm or less, 54 μm or less, 53 μm or less, 52 μm or less, 51 μm or less, or 50 μm or less, and within this range, the sealing force by a sufficient adhesion force of the pouch film stack UP and BP and the lead tab film “T” may be further improved.

According to an embodiment of the present disclosure, when the inner layer includes the first sealant layer disposed on the barrier layer and the second sealant layer disposed on the first sealant layer, the barrier layer and the inner layer may be formed by extruding the first sealant layer on the barrier layer and combining the second sealant layer on the first sealant layer. That is, the first sealant layer may be a sealant layer formed as it is extruded on the barrier layer, and the second sealant layer may be a sealant layer formed as it is combined on the first sealant layer. As an example, the first sealant layer disposed on the barrier layer and the second sealant layer disposed on the first sealant layer may be formed through an extrusion lamination method of extruding and laminating the first sealant layer between the barrier layer and the second sealant layer. As another detailed example, when the inner layer includes the first sealant layer disposed on the barrier layer and the second sealant layer disposed on the first sealant layer, the barrier layer and the inner layer may be formed through a method of extruding the barrier layer and the inner layer such the first sealant and the second sealant layer are sequentially stacked on the barrier layer.

According to an embodiment of the present disclosure, the pouch film stack UP and BP includes the outer layer, the barrier layer, and the inner layer, the inner layer includes the first sealant layer disposed on the barrier layer, and the second sealant layer disposed on the first sealant layer, the melting point of the first sealant layer is 130° C. or more and 160° C. or less, the melting index of the first sealant layer (230° C., load of 2.16 kg) measured by the ASTM D1238 method is 16 g/10 min or more and 30 g/10 min or less, and the average thickness of the first sealant layer 10 μm or more and 50 μm or less, and the melting point of the second sealant layer is 161° C. or more and 180° C. or less, the melting index of the first sealant layer (230° C., load of 2.16 kg) measured by the ASTM D1238 method is 5 g/10 min or more and 15 g/10 min or less, and the average thickness of the first sealant layer 30 μm or more and 70 μm or less.

According to an embodiment of the present disclosure, the pouch film stack UP and BP includes the outer layer, the barrier layer, and the inner layer, the inner layer includes the first sealant layer disposed on the barrier layer, and the second sealant layer disposed on the first sealant layer, the melting point of the first sealant layer is 130° C. or more and 150° C. or less, the melting index of the first sealant layer (230° C., load of 2.16 kg) measured by the ASTM D1238 method is 16 g/10 min or more and 30 g/10 min or less, and the average thickness of the first sealant layer 10 μm or more and 50 μm or less, and the melting point of the second sealant layer is 120° C. or more and 160° C. or less, the melting index of the first sealant layer (230° C., load of 2.16 kg) measured by the ASTM D1238 method is 5 g/10 min or more and 15 g/10 min or less, and the average thickness of the first sealant layer 30 μm or more and 70 μm or less.

According to one embodiment of the present disclosure, the pouch film stack UP and BP may have an average thickness of 170 μm or more and 200 μm or less. As a detailed example, the pouch film stack UP and BP may have an average thickness of 170 μm or more, 171 μm or more, 172 μm or more, 173 μm or more, 174 μm or more, 175 μm or more, 176 μm or more, 177 μm or more, 178 μm or more, 179 μm or more, or 180 μm or more, and 200 μm or less, 199 μm or less, 198 μm or less, 197 μm or less, 196 μm or less, 195 μm or less, 194 μm or less, 193 μm or less, 192 μm or less, 191 μm or less, 190 μm or less, 189 μm or less, 188 μm or less, 187 μm or less, 186 μm or less, or 185 μm or less, and while protecting the secondary battery within this range, it is possible to prevent the thickness of the secondary battery from being excessively increased by the exterior material.

According to an embodiment of the present disclosure, in the sealing of S30, the sealing temperature may be 180° C. or more and 240° C. or less. As a specific example, during the sealing, the sealing temperature may be 180° C. or more, 185° C. or more, 190° C. or more, 195° C. or more, or 200° C. or more, and may be 240° C. or less, 235° C. or less, 230° C. or less, 225° C. or less, or 220° C. or less. The sealing temperature may be adjusted by using heat energy applied to the first sealing block and the second sealing block 20, specifically, by using the temperatures of the first area 11 and 21.

According to an embodiment of the present disclosure, in the sealing of S30, the sealing time may be 1.5 seconds or more and 2.7 seconds or less. In a detailed example, the sealing time may be 1.5 seconds or more, 1.6 seconds or more, 1.7 seconds or more, or 1.8 seconds or more, and may be 2.7 seconds or less, 2.6 seconds or less, 2.5 seconds or less, or 2.4 seconds or less.

According to an embodiment of the present disclosure, in the sealing of S30, the sealing pressure may be 0.1 MPa or more and 0.5 MPa or less. As a detailed example, the sealing pressure may be 0.1 MPa or more, or 0.2 MPa or more, and may be 0.5 MPa or less, or 0.4 MPa or less.

According to an embodiment of the present disclosure, when the sealing temperature, the sealing time, and the sealing pressure are adjusted as described above, a high peeling strength is secured for the inner layer of the pouch film stack UP and BP and the sealing part between the lead tab film “T”, and the polymer material pushed out from the sealed portion in the tab part is uniformly formed in the unsealed portion, and thus, the thickness of the inner layer may be prevented from being decreased, so that insulation defects can be prevented and a long-term reliability, such as a chemical resistance, may be improved.

Hereinafter, embodiments of the present disclosure will be described in detail so that a person having an ordinary skill in the art, to which the present disclosure pertains, may easily practice the present disclosure. However, the present disclosure may be implemented in various different forms and is not limited to the embodiments described herein.

### Manufacturing Example

Polypropylene was extruded between one surface of an aluminum thin film having an average thickness of 60 μm as the barrier layer and one surface of a unstretched polypropylene film having an average thickness of 50 μm as the second sealant layer to form the first sealant layer having an average thickness of 30 μm to manufacture a film stack having an aluminum thin film/first sealant layer/second sealant layer structure. Furthermore, a nylon film having an average thickness of 25 μm and a polyethylene terephthalate having an average thickness of 12 μm were adhered to an opposite surface of the aluminum thin film through a dry lamination method to manufacture a pouch film stack of a PET/nylon/aluminum thin film/first sealant layer/second sealant layer structure.

Here, the polypropylene of the first sealant layer had a melting point of 145° C., a melting index (230° C., load of 2.16 kg) measured through the ASTM D1238 method was 24 g/10 min, the unstretched polypropylene of the second sealant layer had a melting point of 140° C., and a melting index (230° C., load of 2.16 kg) measured through the ASTM D1238 method was 12 g/10 min.

### Experimental Example 1: Formation of Third Area

### First to Third Embodiments

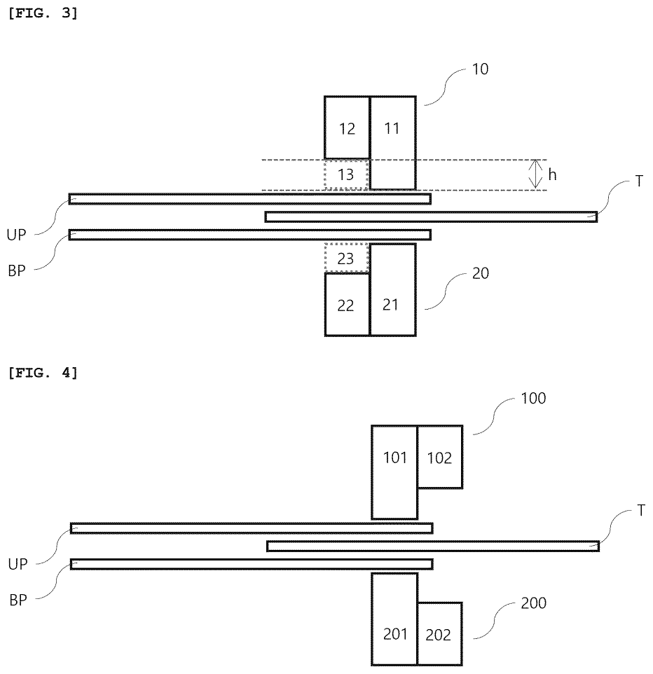

By using the sealing apparatus illustrated in FIG. 3 and the pouch film stack manufactured in the above manufacturing example, sealing was carried out at a sealing temperature of 220° C., a sealing time of 2.4 seconds, and a sealing pressure of 0.4 MPa so that the residual rate (a ratio of the thickness of the inner layer in the sealing part to the thickness of the inner layer of the pouch film stack) of the thickness of the inner layer was 70%, and immediately after the sealing, the temperature of the third area 13 and 23 was measured by an infrared thermometer, and the result is represented in Table 1.

Furthermore, a change in the thickness of the sealing parts manufactured in the first to third embodiments were observed in the following manner and are represented in Table 1.

### First to Third Comparative Example

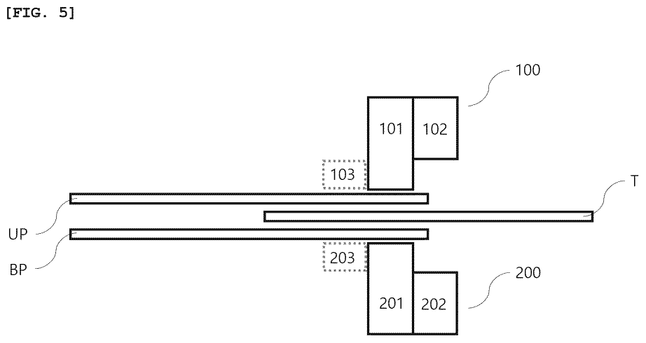

By using the sealing apparatus illustrated in FIG. 5 and the pouch film stack manufactured in the above manufacturing example, sealing was carried out at a sealing temperature of 220° C., a sealing time of 2.4 seconds, and a sealing pressure of 0.4 MPa so that the residual rate (a ratio of the thickness of the inner layer in the sealing part to the thickness of the inner layer of the pouch film stack) of the thickness of the inner layer was 70%, and immediately after the sealing, the temperature of areas 103 and 203 of the third area was measured by an infrared thermometer, and the result is represented in Table 1.

Furthermore, a change in the thickness of the sealing parts manufactured in the first to third embodiments were observed in the following manner and are represented in Table 1.

### Fourth to Sixth Embodiments

By using the sealing apparatus illustrated in FIG. 3 and the pouch film stack manufactured in the above manufacturing example, sealing was carried out at a sealing temperature of 220° C., a sealing time of 1.8 seconds, and a sealing pressure of 0.2 MPa so that the residual rate (a ratio of the thickness of the inner layer in the sealing part to the thickness of the inner layer of the pouch film stack) of the thickness of the inner layer was 70%, and immediately after the sealing, the temperature of the third area 13 and 23 was measured by an infrared thermometer, and the result is represented in Table 1.

Furthermore, a change in the thickness of the sealing parts manufactured in the fourth to sixth embodiments were observed in the following manner and are represented in Table 1.

### Fourth to Sixth Comparative Examples

By using the sealing apparatus illustrated in FIG. 5 and the pouch film stack manufactured in the above manufacturing example, sealing was carried out at a sealing temperature of 220° C., a sealing time of 1.8 seconds, and a sealing pressure of 0.2 MPa so that the residual rate (a ratio of the thickness of the inner layer in the sealing part to the thickness of the inner layer of the pouch film stack) of the thickness of the inner layer was 70%, and immediately after the sealing, the temperature of areas 103 and 203 of the third area was measured by an infrared thermometer, and the result is represented in Table 1.

Furthermore, a change in the thickness of the sealing parts manufactured in the fourth to sixth comparative examples were observed in the following manner and are represented in Table 1.

A change in thickness: the pouch outer material was cut in a direction that was perpendicular to the lead tab film sealing part manufactured in the examples and the comparative examples, epoxy molding and polishing were performed on the cross section, and a cross-sectional analysis of the lead tab film sealing part and adjacent areas was performed by using an optical device.

It was observed whether there was a point and/or an area, in which the thickness of the inner layer was smaller than 80 μm that was the entire average thickness of the first sealant layer and the second sealant layer in an area, in which the thickness of the inner layer increased adjacent to the lead tab film sealing part from the optical image obtained from the optical device, and when there is no point and/or area that becomes thinner, it was represented by OK, and when there were one or more points and/or areas that become thinner, they were represented by N.G.

TABLE 1

| | Sealing condition | | | | Temper- | |
|---|---|---|---|---|---|---|
| | | | | Residual ratio | ature | |
| | Temper- | | | of thickness of | of third | |
| | ature | Time | Pressure | inner layer 1) | area | Change in |
| Classification | (° C.) | (s) | (MPa) | (%) | (° C.) | thickness |
| First | 220 | 2.4 | 0.4 | 70 | 81.4 | OK |
| embodiment | | | | | | |
| Second | 220 | 2.4 | 0.4 | 70 | 82.7 | OK |
| embodiment | | | | | | |
| Third | 220 | 2.4 | 0.4 | 70 | 84.4 | OK |
| embodiment | | | | | | |
| First | 220 | 2.4 | 0.4 | 70 | 61.0 | N.G |
| comparative | | | | | | |
| example | | | | | | |
| Second | 220 | 2.4 | 0.4 | 70 | 64.3 | N.G |
| comparative | | | | | | |
| example | | | | | | |
| Third | 220 | 2.4 | 0.4 | 70 | 70.1 | N.G |
| comparative | | | | | | |
| example | | | | | | |
| Fourth | 220 | 1.8 | 0.2 | 70 | 80.0 | OK |
| embodiment | | | | | | |
| Fifth | 220 | 1.8 | 0.2 | 70 | 83.1 | OK |
| embodiment | | | | | | |
| Sixth | 220 | 1.8 | 0.2 | 70 | 85.1 | OK |
| embodiment | | | | | | |
| Fourth | 220 | 1.8 | 0.2 | 70 | 60.5 | N.G |
| comparative | | | | | | |
| example | | | | | | |
| Fifth | 220 | 1.8 | 0.2 | 70 | 65.2 | N.G |
| comparative | | | | | | |
| example | | | | | | |
| Sixth | 220 | 1.8 | 0.2 | 70 | 69.4 | N.G |
| comparative | | | | | | |
| example | | | | | | |

1) Residual ratio of thickness of inner layer: ratio of thickness of inner layer in sealing part to thickness of inner layer of pouch film stack

As represented in Table 1, in the first to sixth embodiments using the sealing apparatus according to the present disclosure, it could be identified that there is no area, in which the thickness of the inner layer was smaller than an average thickness of the inner layer of the accommodation space area in an area, in which the thickness of the inner layer increased adjacent to the lead tab film sealing part when a cross section of the pouch outer material in a direction that was perpendicular to the lead tab film sealing part was identified through control of the temperature of the third area without being significantly affected by the sealing condition.

On the other hand, in the first to sixth comparative examples, it could be predicted that, as the temperature of the area 103 and 203 corresponding to the third area is not sufficiently increased, and thus, when the cross section of the pouch outer material was identified in a direction that was perpendicular to the lead tab film sealing part, there was an area, in which the thickness of the inner layer was smaller than the average thickness of the accommodation space area in an area, in which the thickness of the inner layer increased adjacent to the lead tab film sealing part so that there was a problem in the long-term reliability.

### Second Experimental Example: Adjustment of Step Between First Area and Second Area

### Seventh to Tenth Embodiments and Seventh and Eighth Comparative Examples

By using the sealing apparatus illustrated in FIG. 3, in which the step “h” between the first area and the second area was adjusted to the value described in Table 2 below, and the pouch film stack manufactured in the above manufacturing example, sealing was carried out at a sealing temperature of 220° C., a sealing time of 2.4 seconds, and a sealing pressure of 0.4 MPa so that the residual rate (a ratio of the thickness of the inner layer in the sealing part to the thickness of the inner layer of the pouch film stack) of the thickness of the inner layer was 70%, and immediately after the sealing, the temperature of the third area 13 and 23 was measured by an infrared thermometer, and the result is represented in Table 2.

Furthermore, for the sealing parts manufactured in the seventh to tenth embodiments and the seventh and eighth comparative examples, changes in thickness were observed as in the method of the first experimental example, and were represented together with Table 2.

### Eleventh to Fourteenth Embodiments and Ninth and Tenth Comparative Examples

By using the sealing apparatus illustrated in FIG. 3, in which the step “h” between the first area and the second area was adjusted to the value described in Table 2 below, and the pouch film stack manufactured in the above manufacturing example, sealing was carried out at a sealing temperature of 220° C., a sealing time of 1.8 seconds, and a sealing pressure of 0.2 MPa so that the residual rate (a ratio of the thickness of the inner layer in the sealing part to the thickness of the inner layer of the pouch film stack) of the thickness of the inner layer was 70%, and immediately after the sealing, the temperature of the third area 13 and 23 was measured by an infrared thermometer, and the result is represented in Table 2.

Furthermore, for the sealing parts manufactured in the eleventh to fourteenth embodiments and the ninth and tenth comparative examples, changes in thickness were observed as in the method of the first experimental example, and were represented together with Table 2.

TABLE 2

| | Sealing condition | | | | | | |
|---|---|---|---|---|---|---|---|
| | | | | Residual | | | |
| | | | | ratio of | Step “h” | Temper- | |
| | | | | thickness | between first | ature | |
| | Temper- | | | of inner | area and | of third | |
| | ature | Time | Pressure | layer 1) | second area | area | Change in |
| Classification | (° C.) | (s) | (MPa) | (%) | (mm) | (° C.) | thickness |
| Seventh | 220 | 2.4 | 0.4 | 70 | 1.0 | 101.0 | N.G |
| comparative | | | | | | | |
| example | | | | | | | |
| Seventh | 220 | 2.4 | 0.4 | 70 | 1.5 | 91.1 | OK |
| embodiment | | | | | | | |
| Eighth | 220 | 2.4 | 0.4 | 70 | 2.0 | 86.1 | OK |
| embodiment | | | | | | | |
| Ninth | 220 | 2.4 | 0.4 | 70 | 2.5 | 81.4 | OK |
| embodiment | | | | | | | |
| Tenth | 220 | 2.4 | 0.4 | 70 | 3.0 | 76.7 | OK |
| embodiment | | | | | | | |
| Eighth | 220 | 2.4 | 0.4 | 70 | 4.0 | 70.4 | N.G |
| comparative | | | | | | | |
| example | | | | | | | |
| Ninth | 220 | 1.8 | 0.2 | 70 | 1.0 | 99.2 | N.G |
| comparative | | | | | | | |
| example | | | | | | | |
| Eleventh | 220 | 1.8 | 0.2 | 70 | 1.5 | 89.4 | OK |
| embodiment | | | | | | | |
| Twelfth | 220 | 1.8 | 0.2 | 70 | 2.0 | 84.9 | OK |
| embodiment | | | | | | | |
| Thirteenth | 220 | 1.8 | 0.2 | 70 | 2.5 | 80.1 | OK |
| embodiment | | | | | | | |
| Fourteenth | 220 | 1.8 | 0.2 | 70 | 3.0 | 77.0 | OK |
| embodiment | | | | | | | |
| Tenth | 220 | 1.8 | 0.2 | 70 | 4.0 | 69.8 | N.G |
| comparative | | | | | | | |
| example | | | | | | | |

1) Residual ratio of thickness of inner layer: ratio of thickness of inner layer in sealing part to thickness of inner layer of pouch film stack

As represented in Table 2, in the seventh to fourteenth embodiments using the sealing apparatus according to the present disclosure, in which the temperature of the third area was adjusted by adjusting the step “h” between the first area and the second area, it could be identified that there is no area, in which the thickness of the inner layer was smaller than an average thickness of the inner layer of the accommodation space area in an area, in which the thickness of the inner layer increased adjacent to the lead tab film sealing part when a cross section of the pouch outer material in a direction that was perpendicular to the lead tab film sealing part was identified without being significantly affected by the sealing condition.

On the other hand, in the seventh to tenth comparative examples, it could be predicted that, when the cross section of the pouch outer material was identified in a direction that was perpendicular to the lead tab film sealing part while the step “h” between the first area and the second area or the temperature of the third area was not sufficiently adjusted, there was an area, in which the thickness of the inner layer was smaller than the average thickness of the accommodation space area in an area, in which the thickness of the inner layer increased adjacent to the lead tab film sealing part so that there was a problem in the long-term reliability.

### Acknowledgement

The present disclosure is a result that was obtained by performing the following project support.
Project Number: 20022450
Department: Ministry of Trade, Industry and Energy
Project management (professional) institution: Korea Institute of Industrial Technology Planning and Evaluation
Research business: Development of material and part technology (Top company)
Research project: Development of next-generation secondary battery pouch that may implement twice or more high adhesive strength (60° C.)
Contribution rate: 1/1
Project implementation organization: Yulchon Chemical Co., Ltd
Research Period: Jan. 1, 2024 to Dec. 31, 2024

By using the apparatus for sealing a pouch type secondary battery, insulation defects may be prevented and a long-term reliability, such as a chemical resistance, may be improved by evenly forming a polymer material pushed from the sealed portion in a tab part even in the unsealed portion to prevent a thickness of a sealant layer from being smaller when the pouch film stack and the lead tab film are sealed in performing sealing.

1. An apparatus for sealing a pouch type secondary battery, by which an upper pouch film stack, a lower pouch film stack, a lead tab film disposed between the upper pouch film stack and the lower pouch film stack are seated, the apparatus comprising:
a first sealing block configured to press an outer layer of the upper pouch film stack in an area, in which the upper pouch film stack and any one surface of the lead tab film correspond to each other; and
a second sealing block configured to press an outer layer of the lower pouch film stack in an area, in which the lower pouch film stack and an opposite surface of the lead tab film correspond to each other,
wherein at least one of the first sealing block and the second sealing block includes a first area directly contacting the outer layer of the pouch film stack and a second area not directly connecting the outer layer of the pouch film stack,
wherein the second area is provided in a direction of an accommodation space of the pouch type secondary battery, the first area and the second area have a step with respect to a surface, on which the first area directly contacts the outer layer of the pouch film stack, and a third area including an empty space is formed between the second area and the outer layer of the pouch film stack, and
wherein the third area has a heated atmosphere compared to external atmospheres of the first area and the second area such that a thickness of an inner layer of the pouch film stack does not have a thinner area than an average thickness of an inner layer of an accommodation space area of the pouch type secondary battery in an area, in which the thickness of the inner layer of the pouch film stack increases adjacent to a lead tab film sealing part, when a cross section of an pouch outer material is identified in a direction being perpendicular to the lead tab film sealing part manufactured to be sealed.

2. The apparatus of claim 1, wherein the step is 1.25 mm or more and 3.5 mm or less.

3. The apparatus of claim 1, wherein a temperature of the first area is 180° C. or more and 240° C. or less.

4. The apparatus of claim 1, wherein a temperature of the third area is 73.0° C. or more and 96.0° C. or less.

5. A method for sealing a pouch type secondary battery, the method comprising:
disposing an electrode assembly in an accommodation space of the pouch type secondary battery formed by an upper pouch film stack and a lower pouch film stack (S10);
disposing a lead tab withdrawn from the electrode assembly, between the upper pouch film stack and the lower pouch film stack; and
sealing the upper pouch film stack, the lower pouch film stack, and a lead tab film disposed between the upper pouch film stack and the lower pouch film stack by using a sealing apparatus,
wherein the sealing apparatus is the apparatus of claim 1.

6. The method of claim 5, wherein the upper pouch film stack and the lower pouch film stack include an outer layer, a barrier layer, and an inner layer.

7. The method of claim 6, wherein the inner layer includes at least one selected from the group consisting of polyethylene, polypropylene, polycarbonate, polyethylene terephthalate, polyvinyl chloride, acrylic polymers, polyacrylonitrile, polyimide, polyamide, cellulose, aramid, nylon, polyester, polyparaphenylene benzobisoxazole, polyarylate, Teflon, and glass fiber.

8. The method of claim 6, wherein the inner layer includes a first sealant layer disposed on the barrier layer, and a second sealant layer disposed on the first sealant layer.

9. The method of claim 8, wherein a melting point of the first sealant layer is 130° C. or more and 160° C. or less.

10. The method of claim 8, wherein a melting index of the first sealant layer, which is measured in a condition of a temperature of 230° C. and a load of 2.16 kg through an ASTM D1238 method, is 16 g/10 min or more and 30 g/10 min or less.

11. The method of claim 8, wherein a melting point of the second sealant layer may be 161° C. or more and 180° C. or less.

12. The method of claim 8, wherein a melting point of the second sealant layer may be 120° C. or more and 160° C. or less.

13. The method of claim 8, wherein a melting index of the second sealant layer, which is measured in a condition of a temperature of 230° C. and a load of 2.16 kg through an ASTM D1238 method, may be 5 g/10 min or more and 15 g/10 min or less.

14. The method of claim 5, wherein in the sealing of S30, a sealing temperature is 180° C. or more and 240° C. or less.

15. The method of claim 5, wherein in the sealing of S30, a sealing time period is 1.5 seconds or more and 2.7 seconds or less.

16. The method of claim 5, wherein in the sealing of S30, a sealing pressure is 0.1 MPa or more and 0.5 MPa or less.
